(19) United States
(12) Patent Application Publication
(10) Pub. No.: US 2024/0419314 A1
(43) Pub. Date: Dec. 19, 2024

(54) DATA PROCESSING METHOD, APPARATUS, DEVICE, AND STORAGE MEDIUM

(71) Applicant: Beijing Zitiao Network Technology Co., Ltd., Beijing (CN)

(72) Inventors: Zheneng Liu, Beijing (CN); Yongsen Feng, Beijing (CN)

(21) Appl. No.: 18/818,280

(22) Filed: Aug. 28, 2024

(30) Foreign Application Priority Data
Aug. 31, 2023 (CN) 202311116948.9

(51) Int. Cl. G06F 3/04845; G06F 40/177

(52) U.S. Cl. CPC G06F 3/04845; G06F 40/177

(57) ABSTRACT

The present disclosure provides a data processing method, an apparatus, a device, and a storage medium. Specifically, data can be displayed to a user via a table in the first place. Then, the user can trigger a display instruction for a first data range in the table. In accordance with the display instruction triggered by the user, a data processing assembly can be displayed. The data processing assembly includes a text input area, through which the user can input a target text. After the data processing instruction for the data processing assembly is obtained, the data in the first data range can be processed in accordance with the target text and an adjustment result can be displayed. As such, the data is automatically processed without the user knowing the specific processing rules such that a usage threshold is lowered and a user experience is boosted.

### CROSS-REFERENCE TO RELATED APPLICATION(S)

This application claims priority to Chinese Application No. 202311116948.9, filed on Aug. 31, 2023, the disclosures of which are incorporated herein by reference in their entities.

### FIELD

The present disclosure relates to the computer field, and more specifically, to a data processing method, an apparatus, a device, and a storage medium.

### BACKGROUND

With advance of computer technologies, it is a common technical approach to display data in a table. When the data are displayed in tables, data of same property may be displayed in the same row/column, to facilitate users to view.

Besides, while viewing the data, the users also may adjust arrangement and display mode of the data in the table. For example, the users may rank, filter and highlight the data to adjust arrangement and display mode of the data in the table. These operations may further embody characteristics of the data to facilitate the users to view.

At present, an application for viewing data may be pre-deployed with a plurality of data processing functions. However, it is still quite hard for the users to use.

### SUMMARY

To solve the problems in the prior art, the present disclosure provides a data processing method, an apparatus, a device, and a storage medium.

On this basis, the present disclosure proposes the following technical solution:

In a first aspect, the present disclosure provides a data processing method, comprising:
displaying, in response to a display instruction for a first data range in a table, a data processing assembly including a text input area;
processing, in response to a data processing instruction for the data processing assembly, data in the first data range in accordance with a target text received via the text input area and displaying an adjustment result.

In some possible implementations, the target text includes a target instruction text indicating a first operation instruction, and processing the data in the first data range includes:
executing a first adjustment instruction on the data in the first data range.

In some possible implementations, the target instruction text further includes a condition information text indicating first condition information, and executing the first adjustment instruction on the data in the first data range includes:
determining first target data, the first target data matching the first condition information;
processing the first target data in accordance with the first operation instruction.

In some possible implementations, processing the first target data in accordance with the first operation instruction includes:
displaying the first target data in a second data range in the first data range; or
displaying the first target data in a first display mode, the target text further including a display mode indication text indicating the first display mode.

In some possible implementations, processing the first target data in accordance with the first operation instruction includes displaying the first target data in a second data range in the first data range, and displaying the first target data in the second data range in the first data range includes:

Hiding display of non-first target data in the first data range.

In some possible implementations, processing data in the first data range in accordance with a target text received via the text input area includes:
adding an instruction control into at least one cell corresponding to the first data range.

In some possible implementations, prior to processing the data in the first data range, the method further includes:
sending the target text to a target model; and
receiving a first processing rule sent by the target model; and
processing the data in the first data range includes:
processing data in the first data range in accordance with the first processing rule.

In some possible implementations, prior to processing the data in the first data range in accordance with the first processing rule, the method further includes:
verifying feasibility of the first processing rule in accordance with the data in the first data range.

In a second aspect, the present disclosure provides a data processing method, the method is applied to a service end of a target software having a table processing function, and the method comprises:
obtaining a target text, the target text being obtained from a procedure of processing data in a first data range in a table by a client of the target software and sent to the service end;
sending the target text to a target model;
receiving a first processing rule fed back by the target model, the first processing rule being for processing the data in the first data range.

In some possible implementations, after sending the target text to the target model, the method further comprises:
receiving instruction parsing information sent by the target model, the instruction parsing information being obtained from semantic parsing of the target text;
determining at least one intermediate processing rule in accordance with the instruction parsing information;
sending to the target model information of the at least one intermediate processing rule, the first processing rule being determined from the plurality of intermediate processing rules.

In some possible implementations, the instruction parsing information includes a first vector corresponding to the target text;
determining a plurality of intermediate processing rules in accordance with first parsing information includes:
obtaining feature vectors of a plurality of candidate processing rules;
determining at least one intermediate processing rule from the plurality of candidate processing rules in accordance with the first vector and the features vectors of the candidate processing rules.

In a third aspect, the present disclosure provides a data processing apparatus, comprising:
a display unit displaying, in response to a display instruction for a first data range in a table, a data processing assembly including a text input area;
a processing unit for processing, in response to a data processing instruction for the data processing assembly, data in the first data range in accordance with a target text received via the text input area and displaying an adjustment result;
wherein the display unit also displays adjusted data in the first range.

In some possible implementations, the target text includes a target instruction text indicating a first operation instruction; and the processing unit specifically executes the first adjustment instruction on data in the first data range.

In some possible implementations, the target instruction text further includes a condition information text indicating first condition information; and the processing unit specifically determines first target data, the first target data matching the first condition information; and processes the first target data in accordance with the first operation instruction.

In some possible implementations, the processing unit specifically displays the first target data in a second data range in the first data range; or displays the first target data in a first display mode, the target text further including a display mode indication text indicating the first display mode.

In some possible implementations, processing the first target data in accordance with the first operation instruction includes displaying the first target data in a second data range in the first data range; and the display unit specifically hides non-first target data in the first data range.

In some possible implementations, the processing unit also adds an instruction control into at least one cell corresponding to the first data range.

In some possible implementations, the apparatus also comprises a sending unit for sending the target text to a target model and a receiving unit for receiving a first processing rule sent by the target model; the processing unit also processes data in the first data range in accordance with the first processing rule.

In some possible implementations, the processing unit also verifies feasibility of the first processing rule in accordance with the data in the first data range.

In a fourth aspect, the present disclosure proposes a data processing apparatus, the apparatus is applied to a service end of a target software having a table processing function, and the apparatus comprises: an obtaining unit for obtaining a target text, the target text being obtained from a procedure of processing data in a first data range in a table by a client of the target software and sent to the service end; a sending unit for sending the target text to a target model; and a receiving unit for receiving a first processing rule fed back by the target model, the first processing rule being for processing the data in the first data range.

In some possible implementations, the apparatus also comprises a processing unit; the receiving unit also receives instruction parsing information sent by the target model, the instruction parsing information being obtained from semantic parsing of the target text; the processing unit determines at least one intermediate processing rule in accordance with the instruction parsing information; and the sending unit also sends to the target model information of the at least one intermediate processing rule, the first processing rule being determined from the plurality of intermediate processing rules.

In some possible implementations, the instruction parsing information includes a first vector corresponding to the target text; and the processing unit specifically obtains feature vectors of a plurality of candidate processing rules; and determines at least one intermediate processing rule from the plurality of candidate processing rules in accordance with the first vector and the features vectors of the candidate processing rules.

In a fifth aspect, the present disclosure proposes an electronic device, comprising:
one or more processors;
a storage unit having one or more programs stored thereon;
wherein when the one or more programs are executed by the one or more processors, the one or more processors are caused to implement the method according to the first aspect or the method according to the second aspect.

In a sixth aspect, the present disclosure proposes a computer-readable medium on which computer programs are stored, wherein the programs, when executed by a processor, implement the method according to the first aspect or the method according to the second aspect.

In a seventh aspect, the present disclosure proposes a computer program product, wherein the computer program product, when running on a device, enables the device to execute the method according to the first aspect or the method according to the second aspect.

Accordingly, the present disclosure achieves the following advantages effects.

The present disclosure provides a data processing method, an apparatus, a device, and a storage medium. Specifically, the data may be displayed to the users via tables in the first place. Then, the users may trigger a display instruction for the first data range in the table. In accordance with the display instruction triggered by the users, the data processing assembly may be displayed. The data processing assembly includes the text input area, through which the users may input the target text. After the data processing instruction for the data processing assembly is obtained, the data in the first data range may be processed in accordance with the target text and an adjustment result is displayed. In other words, if the users need to process the data within the first data range in the table, the users may first trigger the display instruction, then input the target text into the text input area and subsequently trigger the data processing instruction to process the data in accordance with the data processing instruction. As such, the data are automatically processed, the usage threshold is lowered and the user experience is boosted without the users knowing the specific processing rules.

### BRIEF DESCRIPTION OF THE DRAWINGS

Brief introduction of the drawings required in the description of the specific embodiments or the prior art are to be provided below to more clearly explain the technical solutions according to the embodiments of the present disclosure or in the prior art. It is obvious that the following drawings illustrate some embodiments of the present disclosure and those skilled in the art also may obtain other drawings on the basis those illustrated ones without any exercises of inventive work.

FIG. 1 illustrates a schematic diagram of an application scenario provided by the embodiments of the present disclosure;

FIG. 2 illustrates a flow diagram of the data processing method provided by the embodiments of the present disclosure;

FIG. 3 illustrates a flow diagram of the data processing method provided by the embodiments of the present disclosure;

FIG. 4 illustrates a schematic diagram of interactions of the data processing method provided by the embodiments of the present disclosure;

FIG. 5 illustrates a schematic diagram of a data processing apparatus provided by the embodiments of the present disclosure;

FIG. 6 illustrates a schematic diagram of a data processing apparatus provided by the embodiments of the present disclosure;

FIG. 7 illustrates a schematic diagram of an electronic device provided by the embodiments of the present disclosure.

### DETAILED DESCRIPTION OF EMBODIMENTS

The embodiments of the present disclosure will be described in more details with reference to the drawings. Although the drawings illustrate some embodiments of the present disclosure, it should be appreciated that the present disclosure can be implemented in various manners and should not be limited to the embodiments explained herein. On the contrary, the embodiments are provided to make the present disclosure more thorough and complete. It should be appreciated that the drawings and the embodiments of the present disclosure are provided only for exemplary purpose, rather than restricting the protection scope of the present disclosure.

It is to be understood that respective steps disclosed in the method implementations of the present disclosure may be executed in different orders and/or in parallel. Besides, the method implementations may include additional steps and/or omit the demonstrated steps. The scope of the present disclosure is not restricted in this regard.

As used herein, the term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” The term “some embodiments” is to be read as “at least some embodiments”. Related definitions of other terms may be provided in the following description.

It is to be noted that “first” and “second” are disclosed in the present disclosure merely for distinguishing different apparatuses, modules or units, rather than restricting the sequence of the functions executed by the apparatuses, modules or units or the interdependence.

It is to be noted that the terms “one” and “more” disclosed in the present disclosure are exemplary rather than restrictive. Those skilled in the art should understand that the above terms are to be read as “one or more” unless indicated otherwise in the context.

It is both convenient and efficient to process data by tables. For the moment, an increasing number of users choose to process data by tables, and many applications accordingly provide the function of processing data by tables. The function that enables data processing by tables may be referred to as table function. A software having table function may be known as table software. For example, to make it convenient for users to process data, the table function may be integrated in an Instant Messaging (IM) software. Correspondingly, the IM software inheriting the table function may be known as table software.

When the data are processed by tables, users may be required to calculate, convert and analyze the data in the tables. In actual applications, the users may perform complicated operations on the data in the tables. If the data are manually processed by the users, it may result in low processing efficiency and poor user experience.

To facilitate user's operations, processing logic of some data processing functions may be integrated into the table software. As such, the users may process the data by calling the data processing functions integrated in the table software. For example, the users may process the data in the table via triggering an operation control. Alternatively, the users may process the data in the table by inputting an instruction. Thus, the data processing efficiency is improved and the user experience is boosted.

However, the processing logic of some data processing functions may be complicated. When the data processing function is called, the users also may be required to make a choice in accordance with the actual situation of the data in the table or even input auxiliary instruction information or reference information in addition to calling the data processing function via instructions. In such case, the users should understand the method for using the data processing function, i.e., the threshold for using such function is high.

Further, as the functions of the table software become diversified, more data processing functions are provided by the table software. Although the functions of the table software are diversified, it may possibly cause inconvenience for users to use.

On one hand, the users may not understand the data processing functions possessed by the table software and thus could not use the required data processing functions. In actual application scenarios, the users may use the table software as a tool for data processing, but would not give a thorough study on the table software. Accordingly, the users may fail to understand the data processing functions possessed by the table software. Even if the data processing functions provided by the table software can satisfy the needs of user operations, the users can hardly consider processing the data via the data processing functions of the table software due to a lack of sufficient knowledge.

On the other hand, even if the users understand that the table software has such function, they may fail to find the way for using the function and thus could not process the data using the function.

Specifically, in the practical scenarios, if the functions provided by the table software are triggered by an operation control and the users could not find the corresponding operation control, it is impossible for the users to use the function corresponding to the operation control.

In actual scenarios, the table software has a limited display area. To save the display area of the table software, operation controls corresponding to some data processing functions that are used less frequently may be deployed at a less obvious location in the display interface or hidden in an expandable menu, or displayed in the form of small icons. Therefore, even if the users know that the table software provides a given data processing function, they may not find the operation control corresponding to this data processing function and thus fail to call a giant data processing function to process the data.

Hence, the users may lack knowledge of the table software and fail to utilize the functions provided by the table software for data processing. The user experience is poor.

To address the problems in the prior art, embodiments of the present disclosure provide a data processing method, which is to be introduced in details below with reference to the accompanying drawings.

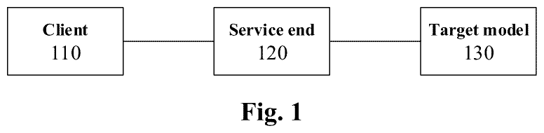

First, exemplary application scenarios of the embodiments of the present disclosure are introduced. Referring to FIG. 1, it illustrates a schematic framework of the exemplary application scenario provided by the embodiments of the present disclosure. The implementation shown by FIG. 1 includes a client 110, a service end 120 and a target model 130, wherein the client 110 and the service end 120 may be connected via networks, so are the service end 120 and the target model 130.

The client 110 may run on a terminal device used by the users. For example, the client 110 may run on cell phones and computers of the users among other terminal devices. The service end 120 may run on a server or server cluster to provide service to the client 110. Data may exchange between the client 110 and the service end 120.

The target model 130 may run on a server or server cluster. Optionally, the server (or server cluster) for fulfilling target 0 and the server (or server cluster) for implementing the service end 120 may be the same or different. The target model 130 externally provides its service. For example, a target model may run in the target model 130. The service end 120 may send data to be processed to the target model 130, which target model 130 may process the data to be processed via the target model and send the processed data to the service end 120. Optionally, the above target model may be Language Model (LM) or Large Language Model (LLM).

Exemplary application scenarios of the embodiments of the present application have been introduced above. The following is an exemplary description of the data processing method provided by the embodiments of the present application.

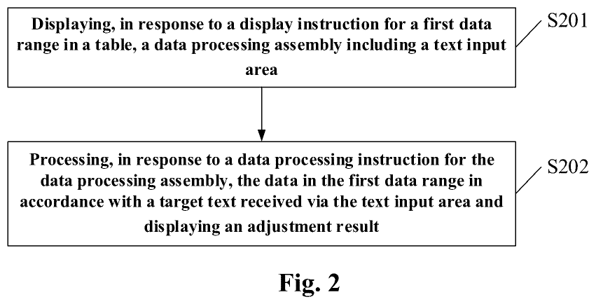

FIG. 2 illustrates a flow diagram of the data processing method provided by the embodiments of the present disclosure, and the embodiments of the present disclosure may be adapted to the application scenarios where data are processed by tables. The data processing method may be executed by a data processing apparatus, which data processing apparatus may be implemented by software.

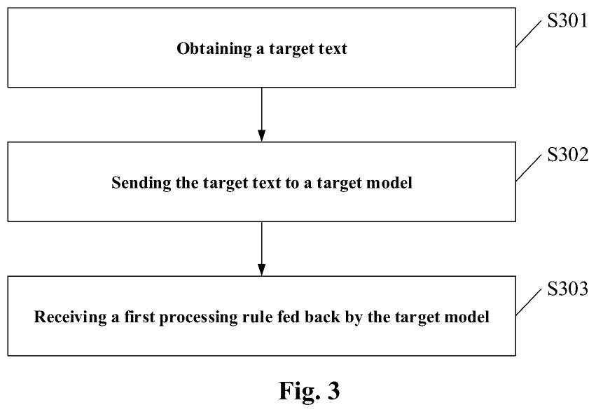

It is to be explained that the data processing apparatus in the embodiments corresponding to FIG. 3 may differ from the data processing apparatus in the embodiments corresponding to FIG. 2. For example, the data processing apparatus in the embodiments corresponding to FIG. 3 may run on the service end of the table software, while the data processing apparatus in the embodiments corresponding to FIG. 2 may run on the client of the table software.

Optionally, the data processing apparatus may be integrated in the client of the table software, wherein the client of the software runs on a terminal device utilized by the users, e.g., cellphone or computer and the like. The client may be an application client or webpage client of the table software. The service end of the software may run on the server or server cluster to provide corresponding services to the client of the software. Optionally, the table software may be Instant Messaging (IM) software with table function. If the data processing apparatus is integrated in the client, the data processing apparatus may communicate with the service end to use the target model via the service end. Optionally, the data processing apparatus may be integrated in the client 110 in the application scenarios shown by FIG. 1. An example of integrating the data processing apparatus in the client is provided below to facilitate introduction.

As shown in FIG. 2, the method specifically includes steps of:

S201: in response to a display instruction for a first data range in the table, displaying a data processing assembly.

In the embodiments of the present disclosure, the data processing apparatus may display a data processing component in accordance with a display instruction for a first data range in the table, wherein the first data range is a data range in the table corresponding to part or whole of the table. The display instruction is triggered by the users. The data processing assembly includes a text input area for receiving texts input by the users. To facilitate the introduction, the data within the first data range may be referred to as first data or target data.

In the embodiments of the present disclosure, the data processing assembly may be displayed based on an operation of the users. The operation corresponds to the display instruction. Specifically, before a display instruction is obtained, the data processing assembly may be in a hidden state. After the display instruction is acquired, the data processing assembly may be displayed. The operation corresponding to the display instruction may include a first operation. The first operation may include an operation of pressing a preset shortcut key, and also may include an operation of clicking a preset control, and may further include an operation of issuing a speech command and the like. Embodiments of the present disclosure are not restricted in the first operation.

Besides, the display instruction is directed at the first data range in the table. Correspondingly, the operation corresponding to the display instruction also may include an operation for determining the first data range. The operation for determining the first data range may be referred to as a second operation. Optionally, the second operation for example may include a box select operation. The users may pick the data to be processed via the box select operation to obtain the first data range.

Optionally, the second operation may be triggered before the first operation. That is, to trigger the display instruction, the users may trigger the second operation and choose the first data range corresponding to the target data to be processed in the table. Next, the users may trigger the first operation to wake up the hidden data processing assembly.

In other words, if the users want to process the target data using a target function, the users may trigger the first operation. After the first operation triggered by the users is obtained, the data processing assembly may be displayed to the users. The data processing assembly includes a text input area. After the data processing assembly is displayed, the users may input a target text in the text input area.

Optionally, the data processing assembly also may include prompt information. The prompt information may correspond to the text input area, to prompt the users to process the data in the table by inputting text information in the text input area.

Optionally, the data processing assembly also may include a data processing control, which data processing control triggers a third operation. The third operation corresponds to the data processing instruction. The third operation and the data processing instruction are to be introduced below and will not be covered here.

In some possible implementations, a corresponding processing rule of the target text may be determined via the model, wherein the model may be a model with Natural Language Processing (NLP) function, e.g., language model or large language model. Optionally, the data processing assembly may correspond to a cloud service corresponding to the model. To facilitate the description, the cloud service may be known as a first cloud service.

That is, the users may call the first cloud service to process the data within the first data range in the table through the target text. Correspondingly, the data processing apparatus may be a software module on the client for implementing the first cloud service. The data processing assembly may be a display area corresponding to the first cloud service. The data processing apparatus may process the data by calling the service end of the first cloud service.

As such, the above first operation may be an operation using the first cloud service. For example, the users may first trigger the second operation to determine a first data display rang, then wake up the menu by triggering a right click operation, and further trigger a left click operation for the operation control corresponding to the first cloud service in the menu.

In the above implementations, the data processing assembly is displayed based on the display instruction. In some other possible implementations, the data processing assembly also may be deployed in a specific area of the interface of the client of the table software, e.g., in a menu bar of the interface of the client. Correspondingly, if the users intend to process the target data, the users may switch the text input cursor to the data processing assembly, so as to input the target text via the text input area of the data processing assembly.

After the data processing assembly is displayed to the users, the users may input the target text in the text input area and trigger the data processing instruction, wherein the target text indicates the intention of the users to process the target data and the data processing instruction initiates a processing flow for the target data. Optionally, the users may obtain the data processing instruction by triggering the third operation. The third operation, for example, may include a click operation triggered by the users for the data processing control. In other words, after completing the input of the target text, the users may trigger the third operation. Correspondingly, the data processing apparatus may obtain the data processing instruction in accordance with the third operation and execute the following step S202.

S202: processing, in response to a data processing instruction for the data processing assembly, the data in the first data range in accordance with a target text received by the text input area and displaying an adjustment result.

Subsequent to receiving the data processing instruction triggered by the users, the data processing apparatus may process the data within the first data range in accordance with the target text received by the text input area and display an adjustment result. Optionally, the processing rule by which the data within the first data range are processed may be referred to as first processing rule. That is, the first processing rule may include first operation instruction, target condition information and first display mode described below.

Optionally, the data processing apparatus may send to the service end the data processing instruction and the target text, so as to process the data within the first data range via the service end in accordance with the target text. The data processing apparatus may receive the adjusted data sent by the service end and display them to the users. Optionally, the service end may parse the target text via the model, and then adjust the data within the first data range on the basis of the parsed data. The contents in this regard may refer to the following text and will not be covered here.

Some implementations related to adjusting the data within the first data range are to be described below. Optionally, the data may be processed on the client; or the data processing apparatus of the client may send the data to the service end to process the data via the service end. The implementations to be introduced below do not restrict the subject that executes data adjustment.

In the embodiments of the present disclosure, the data within the first data range are adjusted in accordance with an indication of the target text. Optionally, the target text may include a target instruction text for indicating the first operation instruction. The first operation instruction matches the adjustment made on the data within the first data range. Optionally, the first operation instruction may be obtained from parsing the target instruction text by the model. That is, when the data within the first data range are being processed, a first adjustment instruction may be executed on the data within the first data range.

In practical scenarios, the users may need to process the data in accordance with some conditions. Correspondingly, the target text input by the users also may include a condition information text for indicating first condition information. Correspondingly, when the data within the first data range are processed based on the target text, the target text may be parsed to obtain the first condition information corresponding to the condition information text. Afterwards, the data are processed in accordance with the first condition information. Optionally, the condition information text and the aforementioned target instruction text may be the same. For example, they may be different parts of the same natural sentence.

When the data within the first data range are being processed in accordance with the first condition information, data matching the first condition information may be determined from the data within the first data range on the basis of the first condition information. The data matching the first condition information may be known as first target data. After determination of the first target data, the first target data may be processed in accordance with the first operation instruction.

Optionally, the first operation instruction may include an instruction for screening conditions, an instruction for ranking conditions and an instruction for setting condition format. They will be introduced below respectively.

In a first possible implementation, the first operation instruction includes an instruction for screening conditions. Correspondingly, after the first target data are determined, the first target data may be displayed in a second data range in the first data range, wherein the second data range may be a pre-selected data range in the first data range. For example, the data range may be a leftmost and uppermost data range in the first data range except for the table header. Besides, non-first target data in the first data range also may be displayed abnormally.

In a second possible implementation, the first operation instruction includes an instruction for ranking conditions. Correspondingly, after the first target data are determined, the data within the first data range may be ranked and the first target data are displayed before the non-first target data.

In a third possible implementation, the first operation instruction includes an instruction for setting condition format. Correspondingly, after the target data are determined, the first target data may be displayed through a first display mode, wherein the first display mode is set by users for displaying the first target data. Optionally, the first display mode may be determined based on the target text. For example, the target text may include a display mode indication text for indicating the first display mode.

The above three possible implementations are introduced below with reference to the actual usage scenarios. It is to be understood that the following text only introduces an implementation, rather than the only implementation.

It is assumed that the target data include data of type A, data of type B and data of type C, and the users want to highlight the data of type A in the target data.

First of all, the users may trigger the first operation and the second operation to display the data processing assembly in a controlled way. For example, the users may first select the target data and trigger the right click operation. In accordance with the right click operation triggered by the users, the client may display an operation menu to the users. The operation menu may include a first cloud service operation control. By triggering the first cloud service operation control, the users may control the client to display the data processing assembly. Next, the users may input into the text input area of the data processing assembly a text of “finding data of type A and highlighting it with yellow background” and trigger a confirmation operation (i.e., the aforementioned third operation).

After the text of “finding data of type A and highlighting it with yellow background” is obtained, the client may send the text to the target model via the service end and receive information resulted from parsing the text by the model. The information may include related information of the first operation instruction, the first condition information and related information of the first display mode, wherein the related information of the first operation instruction indicates that the first operation instruction is an instruction for setting condition type; the first condition information includes related information indicating the data of “type A”; and the related information of the first display mode includes related information indicating “yellow background”.

Next, the data processing apparatus may call an operation interface for setting condition format as provided by the table software, to set the background color of the data of “type A” in the target data to be “yellow” and display to the users via the client.

Embodiments of the present disclosure provide a data processing method. Specifically, the data may be displayed to the users via tables in the first place. Then, the users may trigger a display instruction for the first data range in the table. In accordance with the display instruction triggered by the users, the data processing assembly may be displayed. The data processing assembly includes the text input area, through which the users may input the target text. After the data processing instruction for the data processing assembly is obtained, the data in the first data range may be processed in accordance with the target text and an adjustment result is displayed. In other words, if the users need to process the data within the first data range in the table, the users may first trigger the display instruction, then input the target text into the text input area and subsequently trigger the data processing instruction to process the data in accordance with the data processing instruction. As such, the data are automatically processed, the usage threshold is lowered and the user experience is boosted without the users knowing the specific processing rules.

In some possible implementations, how the data processing apparatus processes the data may deviate from the actual needs of the users. That is, the processing on the target data in accordance with the target text may not satisfy the needs of the users. In some possible implementations, the users may revoke the processing on the target data by triggering operations, to correctly process the target data.

Specifically, if the users want to revoke the processing on the target data, the users may trigger a fourth operation for revoking the processing on the target data. After the fourth operation is obtained, modifications on the target data may be revoked in accordance with the fourth operation and the target data may be displayed in a display area corresponding to the target data.

In some possible implementations, the fourth operation may be triggered by existing shortcut keys or operation controls. For example, the users may trigger the fourth operation using a shortcut key corresponding to the revoke operation. Alternatively, the users also may trigger the fourth operation by clicking the operation control corresponding to the revoke operation.

In some other possible implementations, the users also may trigger the fourth operation via the control in the data processing assembly. To be specific, after the target data are processed according to the first processing rule, a first control may be displayed in the data processing assembly. If the users want to revoke the processing on the target data, the users may trigger the fourth operation via the first control. Optionally, the first control may include prompt information to prompt the users to revoke the processing on the target data via the first control.

Related contents of the data processing apparatus in the client in the data processing method provided by the embodiments of the present disclosure have been introduced above. In some possible implementations, the target text may be processed via the model.

The data processing method provided by the embodiments of the present disclosure is introduced below with reference to FIG. 3 from the angle of the service end of the table software.

FIG. 3 illustrates a flow diagram of a data processing method provided by the embodiments of the present disclosure and the embodiments of the present disclosure are suitable for the application scenarios where data are processed by tables. The data processing method may be executed by a data processing apparatus running on the service end.

It is to be explained that the data processing apparatus in the embodiments corresponding to FIG. 3 and the data processing apparatus in the embodiments corresponding to FIG. 2 may be different. For example, the data processing apparatus in the embodiments corresponding to FIG. 3 may run on the service end of the table software, while the data processing apparatus in the embodiments corresponding to FIG. 2 may run on the client of the table software.

The data processing apparatus may be implemented by software. Optionally, the apparatus may include a model for processing target request data in accordance with example data, or the apparatus may be associated with the model for processing target request data in accordance with example data. Optionally, the above model for example may include LM model or LLM model. In the embodiments of the present disclosure, the model may be referred to as target model.

Optionally, the data processing apparatus may be integrated to the service end of the table software, wherein the service end of the table software may run on the server or the server cluster, to provide corresponding services to the client of the software. If the data processing apparatus is integrated at the service end, the data processing apparatus may communicate with the client to obtain target request data to be processed sent by the client. Optionally, the data processing apparatus also may communicate with the target model to send example data and target request data to the target model. To facilitate introduction, the following explanation is provided by an example of the data processing apparatus integrated to the service end.

As shown in FIG. 3, the method specifically includes the following steps:

S301: obtaining the target text.

In order to process the target data, the users may wake up the data processing assembly on the client of the table software and input the target text via the text input box of the data processing assembly. In accordance with the data processing instruction for the data processing assembly, the client of the table software may send the target text to the service end of the table software. Correspondingly, the data processing apparatus running on the service end of the table software may obtain the target text.

S302: sending the target text to the target model.

After the target text is obtained, the data processing apparatus may send the target text to the target model. Optionally, the target model may be a model with semantic parsing function, e.g., LM or LLM. Correspondingly, the target text may be a natural language text. The first processing rule parsed from the target text may be implemented based on the structured language. For example, the first processing rule may be implemented based on JavaScript (JavaScript Object Notation, JSON) language.

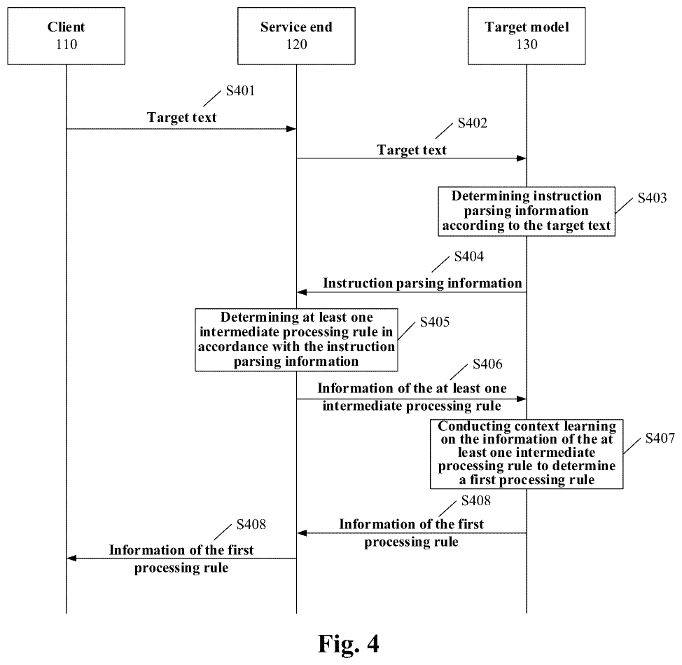

Correspondingly, the data processing apparatus may send prompt information to the target model. Prompt information may include the target text and other information. The determination of the first processing rule via the target model may be explained in details below with reference to the embodiment corresponding to FIG. 4 and will not be covered here.

S303: receiving the first processing rule fed back by the target model.

After obtaining the target text, the target model may parse the target text to determine a corresponding first processing rule. Next, the target model may send the first processing rule to the service end, to process the data within the first data range based on the first processing rule. Optionally, before the data within the first data range is processed based on the first processing rule, feasibility of the first processing rule may be verified.

In the embodiments of the present disclosure, the data processing apparatus may be preconfigured with the capability of parsing the first processing rule. Accordingly, the first processing rule may be parsed after being obtained, so as to process the target data according to a corresponding processing flow. For example, as introduced above, the target model may be LM or LLM and the first processing rule may be implemented based on JSON. Correspondingly, the data processing apparatus may be configured with the capability of parsing JSON.

As introduced above, the table software may be preinstalled with multiple data processing functions. Correspondingly, when the target data is processed in accordance with the first processing rule, the data processing function provided by the table software may be called in accordance with the first processing rule to process the target data. Specifically, an interface for calling the data processing function may be configured in the table software. After the first processing rule is obtained, the corresponding data processing interface may be called in accordance with the first processing rule to process the target data.

In the embodiments of the present disclosure, the target data may be processed by the data processing apparatus in accordance with the first processing rule, and also may be processed by other modules or apparatus.

In some possible implementations, the client of the table software has a data processing function. In such case, the data processing apparatus may call the client of the table software to process the target data in accordance with the first processing rule. For example, if the data processing apparatus runs on the client, the data processing apparatus may locally call the interface of the data processing function, to process the target data in accordance with the first processing rule. Alternatively, if the data processing apparatus runs on the service end, the data processing apparatus may send the first processing rule via the client, or send the instruction information obtained from parsing the first processing rule. The client of the table software may process the target data in accordance with the first processing rule or the instruction information.

In some other possible implementations, the client of the table software lacks the data processing function. The data processing is executed by the service end of the table software. For example, in some cloud service scenarios, the client used by the users is incapable of processing data, so the data processing is implemented by the service end running on the cloud. Accordingly, the data processing apparatus may run on the service end to process the target data in accordance with the first processing rule. Alternatively, if the data processing apparatus runs on the client, the data processing apparatus may send the first processing rule to the service end to process the target data based on the first processing rule.

In the aforementioned implementations, the first processing rule may be determined by the target model in accordance with the target text. The implementation shown by FIG. 1 is taken as an example below to introduce the method for determining the first processing rule via the target model.

In some possible implementations, the client 110 may send the target text to the target model via the service end 120. The target model 130 may parse the target text to determine intentions of the users and further decide the corresponding first processing rule. Afterwards, the related information of the first processing rule is sent to the client 110 via the service end 120.

Optionally, if the target model 130 is a model with context learning capability, such as LM or LLM, the target model 130 may first learn the context of the related information of the processing rule and then process the target text in accordance with the results of the context learning. Thus, by learning the context of the related information of the processing rule, the first processing rule determined by the target model 130 is a better match for the intentions of the users.

Optionally, the information related to the processing rule may be pre-organized and stored. When the target model is required to determine the first processing rule, the service end 120 may obtain the information related to the processing rule and send to the target model 130 the information related to the processing rule via the prompt information, such that the target model 130 may learn the context in accordance with the related information of the processing rule.

From the above introduction, the first processing rule may correspond to the data processing function provided by the table software. According to the first processing rule, the data processing function provided by the table software may be called to process the data. Therefore, during the determination of the first processing rule, the related information for context learning may include related information of the data processing function provided by the table software. For example, the related information for context learning may include files corresponding to the table software and introducing data processing functions provided by the table software.

In actual scenarios, the table software may provide multiple data processing functions. Correspondingly, if there is a large amount of data processing functions and the prompt information is only capable of carrying limited data amount, it is possible that the prompt information may fail to carry the related information of all data processing functions in the table software. As such, the target model 130 could not fully learn the context of the related information of the data processing functions of the table software. The first processing rule thus cannot be accurately determined.

For this, in some possible implementations, the first processing rule may be identified multiple times via the target model 130, which is to be described in details below with reference to FIG. 4.

FIG. 4 illustrates a flow diagram of a method for determining the first processing rule provided by the embodiments of the present disclosure. Embodiments of the present disclosure are suitable for the network architecture shown by FIG. 1, as well as the application scenario of determining the processing rule corresponding to the target text via the target model 130, wherein the target model 130 is a model capable of semantic recognition and the target model 130 also can learn the context. For example, the target model 130 may include LM model or LLM model.

As shown in FIG. 4, the method specifically includes the following steps:

S401: the client 110 sends the target text to the service end 120.

The target text has been introduced above and will not be covered here.

S402: the service end 120 sends the target text to the target model 130.

After obtaining the target text sent by the client 110, the service end 120 may send the target text to the target model 130. Optionally, the service end 120 may send the target text to the target model 130 via the first prompt information.

It is to be explained that before S405, the target model 130 may not learn the context of the target text and is incapable of determining the first processing rule in accordance with the target text.

S403: the target model 130 determines instruction parsing information in accordance with the target text.

After obtaining the target text, the target model 130 may parse semantics of the target text to determine the instruction parsing information corresponding to the target text. Optionally, the above first prompt information may include related information for semantic parsing to enable the target model 130 to perform context learning. As such, the target model 130 first perform the context learning and then parse the target text, to accurately determine the instruction parsing information.

In the embodiments of the present disclosure, the instruction parsing information may be a vector. In other words, the target model 130 may vectorize (embedding) the target text. To facilitate the introduction, the vector corresponding to the instruction parsing information may be known as the first vector.

S404: the target model 130 sends the instruction parsing information to the service end 120.

After determining the instruction parsing information corresponding to the target text, the target model 130 may send to the service end 120 the instruction parsing information.

S405: the service end 120 determines at least one intermediate processing rule in accordance with the instruction parsing information.

After gaining the instruction parsing information, the service end 120 may determine at least one intermediate processing rule in accordance with the instruction parsing information. Besides, a similarity between the intermediate processing rule and the first processing rule is higher than a similarity between the non-intermediate processing rule and the first processing rule.

In the embodiments of the present disclosure, the intermediate processing rule is determined in accordance with the data processing functions provided by the table software. The intermediate processing rule may be a processing rule for calling the data processing functions. That is, the intermediate processing rule may correspond to a data processing function of the table software. When the data is processed according to the intermediate processing rule, it is equivalent to processing the data using the data processing function.

Specifically, a plurality of candidate processing rules may be determined in advance. The candidate processing rules correspond to the data processing functions provided by the table software. After the instruction parsing information is obtained, the intermediate processing rule may be determined from a plurality of candidate processing rules based on the instruction parsing information. In this embodiment, the intermediate processing rule may be determined in accordance with feature vectors of the candidate processing rules. For example, the intermediate processing rule may be determined according to a similarity between the feature vectors of the candidate processing rules and the vector corresponding to the instruction parsing information.

Optionally, the above feature vectors of the candidate processing rules may be obtained from vectorizing descriptive information of the candidate processing rules, wherein the descriptive information of the candidate processing rules describes related information of the candidate processing rules. For example, the descriptive information may include role of the candidate processing rules, interfaces of the data processing functions corresponding to the candidate processing rules and related parameters desired by the candidate processing rules and the like. Optionally, the descriptive information of the processing rule may be determined through introduction information of the table software. The introduction information of the table software, for example, may include specification or user manual of the table software etc.

During actual applications, the descriptive information of the candidate processing rules may be vectorized in advance to obtain the feature vector of each candidate processing rule. Afterwards, the feature vector of the candidate processing rule may be stored into a database 140 (not shown). After the instruction parsing information is obtained, the feature vector of the candidate processing rule may be acquired from the database.

Next, a similarity between the first vector and the feature vector of each candidate processing rule may be calculated respectively. For example, a cosine similarity between the first vector and the feature vector of the candidate processing rule and a double dot (ddot) of the first vector and the feature vector of the candidate processing rule may be calculated and at least one intermediate processing rule is determined based on the calculation result.

S406: the service end 120 sends to the target model 130 information of at least one intermediate processing rule.

After at least one intermediate processing rule is determined, the service end 120 may send to the target model 130 the related information of the at least one intermediate processing rule, wherein the related information of the intermediate processing rule for example may include an expression of the intermediate processing rule, descriptive information of the intermediate processing rule and a vector corresponding to the intermediate processing rule etc.

Specifically, the service end 120 may generate second prompt information and then send the second prompt information to the target model 130. The second prompt information may include information of the intermediate processing rule. Optionally, the second prompt information also may include the target text or the instruction parsing information.

Before the second prompt information is generated, one or more judgments may be made. For example, it is judged whether the target text is irrelevant to the data processing function of the table software, whether the number of tokens included in the second prompt information exceeds a preset threshold, and whether a correlation between the intermediate processing rule and the target text is reasonable or not. After the judgments pass, the corresponding second prompt information may be generated.

S407: the target model 130 learns the context of the information of the at least one intermediate processing rule and determines the first processing rule.

After obtaining the information of the at least one intermediate processing rule, the target model 130 may perform context learning in accordance with the information of the intermediate processing rule and process the target text (or instruction parsing information) after the text learning, so as to determine the information of the first processing rule corresponding to the target text.

S408: the target model 130 sends the information of the first processing rule to the client 110 via the service end 120.

After determining the information of the first processing rule, the target model 130 may send the information of the first processing rule to the client 110 via the server 120. Correspondingly, the data processing apparatus may obtain the information of the first processing rule and display it.

In other words, in case that the related information of the processing rule is too much to be carried by prompt information, the target text may be preliminarily parsed by the target model 130 to determine the instruction parsing information corresponding to the target text. Then, the candidate processing rules may be preliminarily screened by the service end 120 in accordance with the instruction parsing information to find the information of the intermediate processing rule having a high correlation with the instruction parsing information. Accordingly, by the screening of the service end 120, the processing rules irrelevant to the target text may be filtered out and the intermediate processing rule that is highly correlated with the target text is screened. As the number of intermediate processing rules is smaller than the number of candidate processing rules, the prompt information can carry the related information of the intermediate processing rules. Further, since the information of the intermediate processing rules is screened based on the instruction parsing information, a correlation between the intermediate processing rule and the first processing rule is higher than a correlation between the non-intermediate processing rule and the first processing rule. Hence, when the target model 130 performs context learning according to the information of the intermediate processing rule, the accuracy of the target model 130 would not be affected. In such way, the data amount of the prompt information is lowered while the accuracy of the first processing rule is guaranteed.

On the basis of the data processing method provided by the above method embodiments, embodiments of the present disclosure also propose two data processing apparatuses running on the client and the service end of the table software respectively. The data processing apparatuses are to be explained below with reference to the drawings.

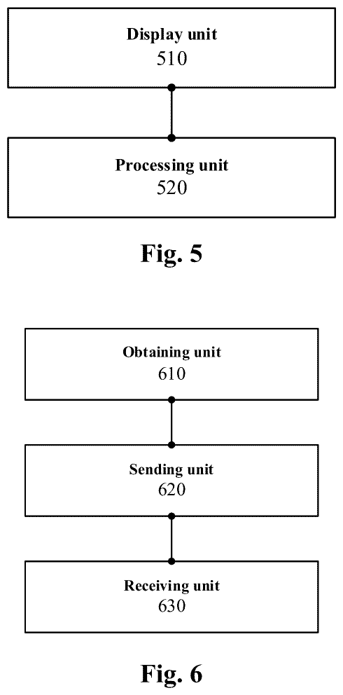

FIG. 5 illustrates a structural diagram of a data processing apparatus running on the client of the table software provided by the embodiments of the present disclosure. As shown in FIG. 5, the data processing apparatus 500 comprises:
a display unit 510 for displaying, in response to a display instruction for a first data range in a table, a data processing assembly including a text input area;
a processing unit 520 for processing, in response to a data processing instruction for the data processing assembly, data in the first data range in accordance with a target text received via the text input area and displaying an adjustment result;
wherein the display unit 510 also displays adjusted data in the first range.

In some possible implementations, the target text includes a target instruction text indicating a first operation instruction; and the processing unit 520 specifically executes the first adjustment instruction on data in the first data range.

In some possible implementations, the target instruction text further includes a condition information text indicating first condition information; and the processing unit 520 specifically determines first target data, the first target data matching the first condition information; and processes the first target data in accordance with the first operation instruction.

In some possible implementations, the processing unit 520 specifically displays the first target data in a second data range in the first data range; or displays the first target data in a first display mode, the target text further including a display mode indication text indicating the first display mode.

In some possible implementations, processing the first target data in accordance with the first operation instruction includes displaying the first target data in a second data range in the first data range; and the display unit 510 specifically hides non-first target data in the first data range.

In some possible implementations, the processing unit 520 also adds an instruction control into at least one cell corresponding to the first data range.

In some possible implementations, the apparatus also comprises a sending unit for sending the target text to a target model and a receiving unit for receiving a first processing rule sent by the target model; the processing unit also processes data in the first data range in accordance with the first processing rule.

In some possible implementations, the processing unit also verifies feasibility of the first processing rule in accordance with the data in the first data range.

FIG. 6 illustrates a structural diagram of a data processing apparatus running on the service end of the table software provided by the embodiments of the present disclosure. As shown in FIG. 6, the data processing apparatus 600 comprises:
an obtaining unit 610 for obtaining a target text, the target text being obtained from a procedure of processing data in a first data range in a table by a client of the target software and sent to the service end;
a sending unit 620for sending the target text to a target model;
a receiving unit 630 for receiving a first processing rule fed back by the target model, the first processing rule being for processing the data in the first data range.

Optionally, the obtaining unit 610 and the receiving unit 630 are the same or different.

In some possible implementations, the apparatus also comprises a processing unit; the receiving unit 630 also receives instruction parsing information sent by the target model, the instruction parsing information being obtained from semantic parsing of the target text; the processing unit determines at least one intermediate processing rule in accordance with the instruction parsing information; and the sending unit 620 also sends to the target model information of the at least one intermediate processing rule, the first processing rule being determined from the plurality of intermediate processing rules.

In some possible implementations, the instruction parsing information includes a first vector corresponding to the target text; and the processing unit specifically obtains feature vectors of a plurality of candidate processing rules; and determines at least one intermediate processing rule from the plurality of candidate processing rules in accordance with the first vector and the features vectors of the candidate processing rules.

In view of the above data processing method provided by the method embodiments, the present disclosure also proposes an electronic device, comprising: one or more processors; a storage unit having one or more programs stored thereon; wherein when the one or more programs are executed by the one or more processors, the one or more processors are caused to implement the data processing method according to any of the above embodiments.

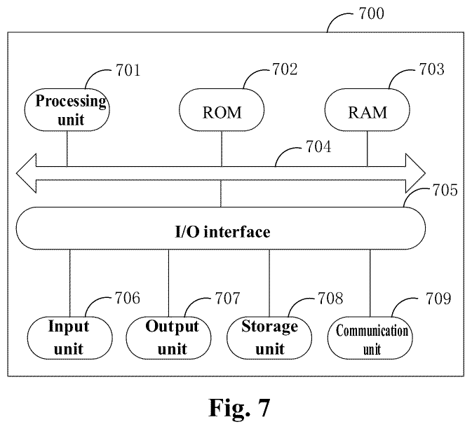

FIG. 7 illustrates a structural diagram of an electronic device 700 suitable for implementing the embodiments of the present disclosure. In the embodiments of the present disclosure, the terminal device may include, but not limited to, mobile terminals, such as mobile phones, notebooks, digital broadcast receivers, PDAs (Personal Digital Assistant), PADs (portable android device), PMPs (Portable Multimedia Player) and vehicle terminals (such as car navigation terminal) and fixed terminals, e.g., digital TVs and desktop computers etc. The electronic device shown in FIG. 7 is just an example and will not put any restrictions on the functions and application ranges of the embodiments of the present disclosure.

According to FIG. 7, the electronic device 700 may include a processing unit (e.g., central processor, graphic processor and the like) 701, which can execute various suitable actions and processing based on the programs stored in the read-only memory (ROM) 702 or programs loaded in the random-access memory (RAM) 703 from a storage unit 708. The RAM 703 can also store all kinds of programs and data required by the operations of the electronic device 700. Processing unit 701, ROM 702 and RAM 703 are connected to each other via a bus 704. The input/output (I/O) interface 705 is also connected to the bus 704.

Usually, input unit 706 (including touch screen, touchpad, keyboard, mouse, camera, microphone, accelerometer, gyroscope and like) and output unit 707 (including liquid crystal display (LCD), speaker and vibrator etc.), storage unit 708 (including tape and hard disk etc.) and communication unit 709 may be connected to the I/O interface 705. The communication unit 709 may allow the electronic device 700 to exchange data with other devices through wired or wireless communications. Although FIG. 7 illustrates the electronic device 700 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a non-transient computer readable medium, wherein the computer programs include program codes for executing the method demonstrated by the flowchart. In these embodiments, the computer programs may be loaded and installed from networks via the communication unit 709, or installed from the storage unit 708, or installed from the ROM 702. The computer programs, when executed by the processing unit 701, performs the above functions defined in the method of the embodiments of the present disclosure.

The electronic device provided by the embodiments of the present disclosure and the data processing method and the file sending method according to the above embodiments belong to the same inventive concept. The technical details not elaborated in these embodiments may refer to the above embodiments. Besides, these embodiments and the above embodiments achieve the same advantageous effects.

On the basis of the above method provided by method embodiments, embodiments of the present disclosure provide a computer storage medium on which computer programs are stored, which programs when executed by a processor implement the data processing method according to any of the above embodiments.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (Hyper Text Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to execute the above data processing method.

Computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit/module should not be considered as the restriction over the unit per se. For example, a speech data collection module also may be described as “data collection module”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

It is to be explained that the various embodiments in the description are described in a progressive manner, and each embodiment focuses on differences from other embodiments, and the same and similar parts of one embodiment may refer to another. Since the system or apparatus disclosed in the embodiments corresponds to the method disclosed in the embodiments, the system or apparatus is described in a simple manner and the similar parts may refer to the description of the method.

It should be appreciated that “at least one” in the present application refers to one or more and “a plurality of” indicates two or more. “And/or” describes an association between two associated objects, which may represent three relations. For example, “A and/or B” may indicate A only, B only and both A and B, where A and B may be singular or plural form. The symbol “/” generally suggests an “OR” relation between the objects linking by it. The term of “at least one of the following” or similar expression indicate any combinations of the following items, including any combinations consisting of one or more items. For instance, at least one of a, b or c may indicate: a; b; c; a and b; a and c; b and c; or a, b and c, where a, b and c may be in singular or plural form.

It is to be explained that relation terms, such as first, second and the like, only distinguish one entity or operation from a further entity or operation, without requiring or suggesting any actual relation or sequence among these entities or operations. Besides, the terms “include”, “contain” or other variants indicate non-exclusive inclusion, such that a procedure, method, object or device consisting of a number of elements not only include these elements, but also contain other elements not listed or inherent elements. Without further limitations, when it is described that “ . . . includes one . . . ”, the procedure, method, object or device including this element may further contain other elements.

The above explanation of the disclosed embodiments enables those skilled in the art to fulfill or use the present disclosure. Many modifications to the embodiments may be obvious for those skilled in the art. General principles defined in the text also can be implemented in other embodiments without deviating from the spirit or scope of the present application. Hence, the present disclosure is not restricted to the embodiments illustrated here; instead, it may have a broadest scope consistent with the disclosed principles and inventive points.

I/We claim:

1. A data processing method, comprising:
displaying, in response to a display instruction for a first data range in a table, a data processing assembly including a text input area; and
processing, in response to a data processing instruction for the data processing assembly, data in the first data range in accordance with a target text received via the text input area and displaying an adjustment result.

2. The method of claim 1, wherein the target text comprises a target instruction text indicating a first operation instruction, and processing the data in the first data range comprises:
executing a first adjustment instruction on the data in the first data range.

3. The method of claim 2, wherein the target instruction text further comprises a condition information text indicating first condition information, and executing the first adjustment instruction on the data in the first data range comprises:
determining first target data, the first target data matching the first condition information; and
processing the first target data in accordance with the first operation instruction.

4. The method of claim 3, wherein processing the first target data in accordance with the first operation instruction comprises:
displaying the first target data in a second data range in the first data range; or
displaying the first target data in a first display mode, the target text further including a display mode indication text indicating the first display mode.

5. The method of claim 4, wherein processing the first target data in accordance with the first operation instruction comprises displaying the first target data in a second data range in the first data range, and displaying the first target data in the second data range in the first data range comprises:
hiding display of non-first target data in the first data range.

6. The method of claim 1, wherein processing data in the first data range in accordance with a target text received via the text input area comprises:
adding an instruction control into at least one cell corresponding to the first data range.

7. The method of claim 1, further comprising, prior to processing the data in the first data range:
sending the target text to a target model; and
receiving a first processing rule sent by the target model; and
processing the data in the first data range comprises:
processing the data in the first data range in accordance with the first processing rule.

8. The method of claim 7, further comprising, prior to processing the data in the first data range in accordance with the first processing rule:
verifying feasibility of the first processing rule in accordance with the data in the first data range.

9. A data processing method, wherein the method is applied to a service end of a target software having a table processing function, and the method comprises:
obtaining a target text, the target text being obtained from a procedure of processing data in a first data range in a table by a client of the target software and sent to the service end;
sending the target text to a target model; and
receiving a first processing rule fed back by the target model, the first processing rule being for processing the data in the first data range.

10. The method of claim 9, further comprising, after sending the target text to the target model:
receiving instruction parsing information sent by the target model, the instruction parsing information being obtained from semantic parsing of the target text;
determining at least one intermediate processing rule in accordance with the instruction parsing information; and
sending to the target model information of the at least one intermediate processing rule, the first processing rule being determined from the plurality of intermediate processing rules.

11. The method of claim 10, wherein the instruction parsing information comprises a first vector corresponding to the target text; and
determining a plurality of intermediate processing rules in accordance with first parsing information comprises:
obtaining feature vectors of a plurality of candidate processing rules; and
determining at least one intermediate processing rule from the plurality of candidate processing rules in accordance with the first vector and the features vectors of the candidate processing rules.

12. An electronic device, comprising:
one or more processors;
a storage unit having one or more programs stored thereon;
wherein when the one or more programs are executed by the one or more processors, the one or more processors are caused to implement a data processing method comprising:
displaying, in response to a display instruction for a first data range in a table, a data processing assembly including a text input area; and
processing, in response to a data processing instruction for the data processing assembly, data in the first data range in accordance with a target text received via the text input area and displaying an adjustment result.

13. The electronic device of claim 12, wherein the target text comprises a target instruction text indicating a first operation instruction, and processing the data in the first data range comprises:
executing a first adjustment instruction on the data in the first data range.

14. The electronic device of claim 13, wherein the target instruction text further comprises a condition information text indicating first condition information, and executing the first adjustment instruction on the data in the first data range comprises:
determining first target data, the first target data matching the first condition information; and
processing the first target data in accordance with the first operation instruction.

15. The electronic device of claim 14, wherein processing the first target data in accordance with the first operation instruction comprises:
displaying the first target data in a second data range in the first data range; or
displaying the first target data in a first display mode, the target text further including a display mode indication text indicating the first display mode.

16. The electronic device of claim 15, wherein processing the first target data in accordance with the first operation instruction comprises displaying the first target data in a second data range in the first data range, and displaying the first target data in the second data range in the first data range comprises:
hiding display of non-first target data in the first data range.

17. The electronic device of claim 12, wherein processing data in the first data range in accordance with a target text received via the text input area comprises:
adding an instruction control into at least one cell corresponding to the first data range.

18. The electronic device of claim 12, wherein the method further comprises, prior to processing the data in the first data range:
sending the target text to a target model; and
receiving a first processing rule sent by the target model; and
processing the data in the first data range comprises:
processing the data in the first data range in accordance with the first processing rule.

19. The electronic device of claim 18, wherein the method further comprises, prior to processing the data in the first data range in accordance with the first processing rule:
verifying feasibility of the first processing rule in accordance with the data in the first data range.
